(19) United States
(12) Patent Application Publication
(10) Pub. No.: US 2011/0162335 A1
(43) Pub. Date: Jul. 7, 2011

(54) VACUUM FILTRATION SYSTEM

(76) Inventor: Tibor FREI, Castle Hill (AU)

(21) Appl. No.: 12/874,161

(22) Filed: Sep. 1, 2010

(30) Foreign Application Priority Data
Sep. 3, 2009 (AU) 2009904223

(51) Int. Cl. B01D 46/00; B01D 46/02

(52) U.S. Cl. 55/372; 55/361; 55/373; 55/380

(57) ABSTRACT

A filtration assembly for use with a suction cleaning device, the filtration assembly including a housing body for housing one or more filters; and a motor driven impeller which generates suction for drawing air and any entrained material into an inlet through the one or more filters and discharging the air through an outlet; wherein the one or more filters includes a first bag filter received by the housing body, the first bag filter including a base portion and a side portion which define a cavity for holding any material that cannot pass through the first bag filter; and, wherein the side portion of the first bag filter is laterally spaced apart from a wall portion of the housing body such that a gap is formed between the side portion and the wall portion.

### CROSS REFERENCE TO RELATED APPLICATIONS

This application claims priority from Australian Patent Application No. 2009904223, filed Sep. 3, 2009, entitled “Vacuum Filtration System.”

### INCORPORATION BY REFERENCE

All publications and patent applications mentioned in this specification are herein incorporated by reference to the same extent as if each individual publication or patent application was specifically and individually indicated to be incorporated by reference.

### FIELD OF THE INVENTION

The invention generally relates to a vacuum filtration system for a suction cleaning device.

### BACKGROUND OF THE INVENTION

Suction cleaning devices such as vacuum cleaners are commonly used to remove and temporarily store dirt, dust or other material. Typically, these cleaning devices use a suction motor to draw in air and entrained material through an inlet, this material is then substantially separated from the air before the air is then discharged via an outlet. The separated material is temporarily stored within the cleaning device before being discarded.

To separate the entrained material such as dirt and dust from the air, the suction cleaning device typically includes a filter between the inlet and the outlet. This filter would usually be made of a material that selectively allows the air to pass, however, captures particles larger than a certain size. As the filter is placed between the inlet and outlet, the filter impedes the flow of air adding “impedance” to the air flow passage through the suction cleaning device. This impedance causes a loading on the suction motor that can cause heating and wear of the suction motor and/or a reduced air flow through the suction cleaning device.

Additionally, as the entrained material is captured by the filter, the filter can become clogged or filled up by the material. In these situations, the impedance of the filter increases and can cause additional loading on the suction motor. This additional loading can cause the suction motor to heat up causing a loss in performance and motor wear. Also, this increased impedance can cause the suction air velocity to decrease, reducing the effectiveness of the suction cleaning device.

To maintain effective cleaning the air velocity at the inlet or “suction velocity” needs to be kept high enough to entrain the material, while the filter needs to be configured to capture this entrained material—typically use of finer filters increases “impedance”.

Accordingly, it is necessary to “impedance balance” the suction cleaning device. Having a low “impedance” to maintain a high suction velocity, while providing filtering that is sufficient to capture and store the desired entrained material.

### SUMMARY OF THE INVENTION

In accordance with the invention there is provided, a filtration assembly for use with a suction cleaning device, the filtration assembly including a housing body for housing one or more filters; and a motor driven impeller which generates suction for drawing air and any entrained material into an inlet through the one or more filters and discharging the air through an outlet; wherein the one or more filters includes a first bag filter received by the housing body, the first bag filter including a base portion and a side portion which define a cavity for holding any material that cannot pass through the first bag filter; and, wherein the side portion of the first bag filter is laterally spaced apart from a wall portion of the housing body such that a gap is formed between the side portion and the wall portion.

In one form, the side portion of the first bag filter is composed of a filtering material through which air is able to be drawn; and, wherein suction of the motor generates airflow in the gap by drawing air through the side portion of the first filter bag.

In one form, the base portion of the filter bag filter is composed of a filtering material through which air is able to be drawn.

In one form, the housing body includes an upper portion through which the first bag filter is received and a lower portion, wherein the side portion and base portion of the first bag filter extend down into the lower portion of the housing body wherein the gap between the wall portion of the housing body and the side portion of the first bag filter is greater at the lower portion of the housing body than the upper portion.

In one form, the side portion and the wall portion diverge towards the lower portion of the housing body, the gap increasing towards the lower portion of the housing body.

In one form, the cross-section of the lower portion is greater than the cross-section of the upper portion such that the cross-section of the housing body fans outwardly from the upper portion to the lower portion; and, wherein the first bag filter has a constant a cross-section that is substantially similar to the cross-section of the upper portion whereby as the first bag filter extends downwardly from the upper portion towards the lower portion, an increasing gap is formed between the side portions of the first bag filter and the housing body.

In one form, the housing body cross section is substantially elliptical in shape.

In one form, wherein the first bag filter is provided in the form of a receptacle extending downwardly into the cavity of the housing body wherein the receptacle has an open end suspended from a lip of an upper portion of the housing body to receive the air and any entrained material.

In one form, the first bag filter is made of a polyester needle felt material that has a filtration efficiency of 96.9% using test dust.

In one form, the first bag filter is composed of one or more polyester fibres with different diameters.

In one form, the one or more polyester fibres with different diameters include polyester fibres of 0.1 mm, 0.2 mm and 0.25 mm in diameter.

In one form, the gap provides a space for the dissipation of heat generated by the motor driver impeller.

In one form, the one or more filters further includes a panel filter to receive the air and any unfiltered entrained material from the first bag filter wherein the panel filter is secured within the lower portion of the housing body.

In one form, the panel filter further includes a layer of polypropylene sandwiched between thin protective polyethylene terephthalate.

In one form, the panel filter is constructed as a vee pleat panel filter such that the filtration surface area is significantly increased over the footprint cross-sectional area of the panel filter.

In one form, the panel filter is a HEPA filter.

In one form, the bag filter and panel filter are able to be installed or removed from the casing through an opening at a top of the upper portion of the housing body.

In one form, the one or more filters include a second bag filter that is housed within the first bag filter.

In one form, the second bag filter is composed of a paper material.

In one form, the second bag filter is micro fibre lined.

In another aspect of the invention there is provided, a filtration assembly for use with a suction cleaning device, the filtration assembly including a housing body for housing a series of filters and an impeller driven by an electric motor for drawing air and any entrained material into an inlet, through the series of filters and discharging the air and any unfiltered entrained material through an outlet; and wherein the housing body includes an upper portion and a lower portion wherein the cross-section of the housing body is greater in the lower portion than the upper portion; and wherein the series of filters includes a first bag filter, a second bag filter housed within the first bag filter and a panel filter through which the air and any entrained material passes; and wherein the first bag filter has a cross-section that is substantially similar to the cross-section of the upper portion whereby as the first bag filter extends downwardly from the upper portion towards the lower portion, an increasing gap is formed between a side portion of the first bag filter and a wall portion of the housing body.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings of which:

FIG. 1 is an exploded parts view of a vacuum filtration system;

FIG. 2 is a front elevation of a suction cleaning device composed of the parts of the vacuum filtration system shown in FIG. 1;

FIG. 3 shows a perspective view of a lid of the filtration assembly with a second bag filter attached;

FIG. 4 shows a perspective view of the filtration assembly with the lid removed and a first bag filter removed;

FIG. 5 shows a front view of the first bag filter;

FIG. 6A shows a front view of the first bag filter inserted into the filtration assembly with arrows to illustrate air flow;

FIG. 6B shows a front view of the first bag filter inserted into the filtration assembly with the first bag filter partially filled with material with arrows to illustrate air flow;

FIG. 7A shows a side view of the first bag filter inserted into the filtration assembly with arrows to illustrate air flow;

FIG. 7B shows a side view of the first bag filter inserted into the filtration assembly with the first bag filter partially filled with some material with arrows to illustrate air flow;

FIG. 8A shows a top view of a panel filter;

FIG. 8B shows a side view of the panel filter;

FIG. 8C shows a perspective view of the panel filter housing;

FIG. 9A shows a top perspective view of a base of the upper canister;

FIG. 9B shows a bottom perspective view of the upper canister;

FIG. 10 shows a HEPA filter;

FIG. 11 shows details of the HEPA filter;

FIG. 12 shows a perspective rear view of a back pack assembly;

FIG. 13 shows another rear view of the back pack assembly.

### DETAILED DESCRIPTION OF THE INVENTION

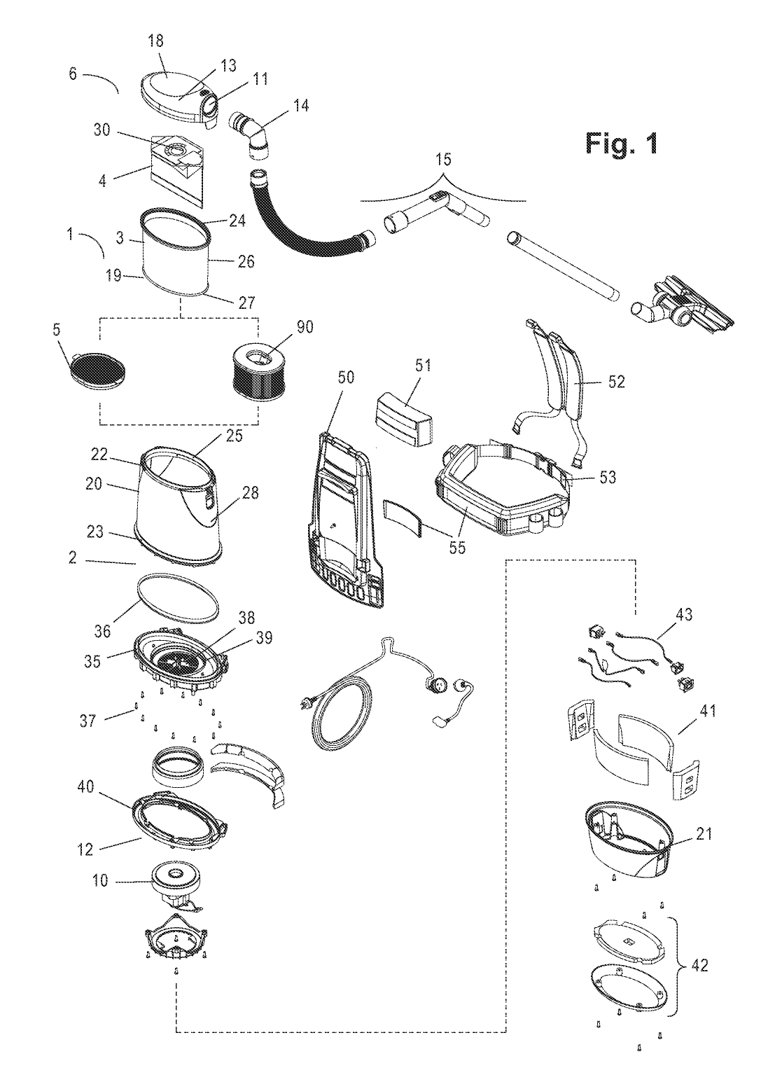

Referring to FIG. 1 there is shown a filtration assembly 1 for use with a suction cleaning device 6, the filtration assembly 1 including a housing body 2 for housing the one or more filters that includes the first bag filter 3, a second bag filter 4 and a panel filter 5. The housing body 2 also houses a motor driven impeller 10, i.e. an impeller driven by an electric motor, which generates suction for drawing air and any entrained material into an inlet 11, through the first bag filter 3, the second bag filter 4 and the panel filter 5 and discharging the air through an outlet 12.

The inlet 11 is provided on a side of a detachable lid 13 and is fed by a first elbow 14 that is inserted in the inlet 11. The air and entrained material enters the first elbow 14 via a vacuum pipe assembly 15.

The housing body 2 includes an upper canister 20 and a lower canister 21. The upper canister 20 includes an upper portion 22 and a lower portion 23 of generally elliptical cross section between which a wall portion 28 extends. The cross-section of the upper portion 22 is generally less than the cross-sectional size of the lower portion 23 such that the cross-section of the upper canister 20 and hence the cross-section of the wall portion 28 generally fans outwardly from the upper portion 22 to the lower portion 23.

The first bag filter 3 includes a rim 24, side portions 26 and a base portion 27 defining an open receptacle. The cross-section 19 of the first bag filter 3 is elliptical in shape and is sized such that the base portion 27 and side portions 26 are able to be received by the upper portion 22. When received by the upper portion 22, the first bag filter 3 is suspended from the rim 24 which engages with a lip 25 on the upper portion 22. In this configuration, the side portions 26 and base portion 27 of the bag filter extend downwardly into the lower portion 23 of the upper canister 20 of the housing body 2.

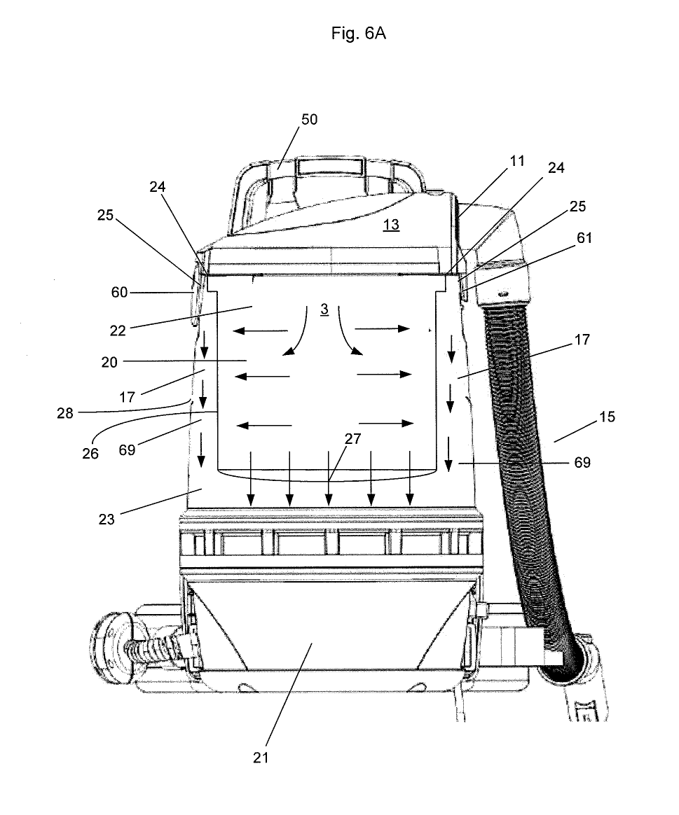

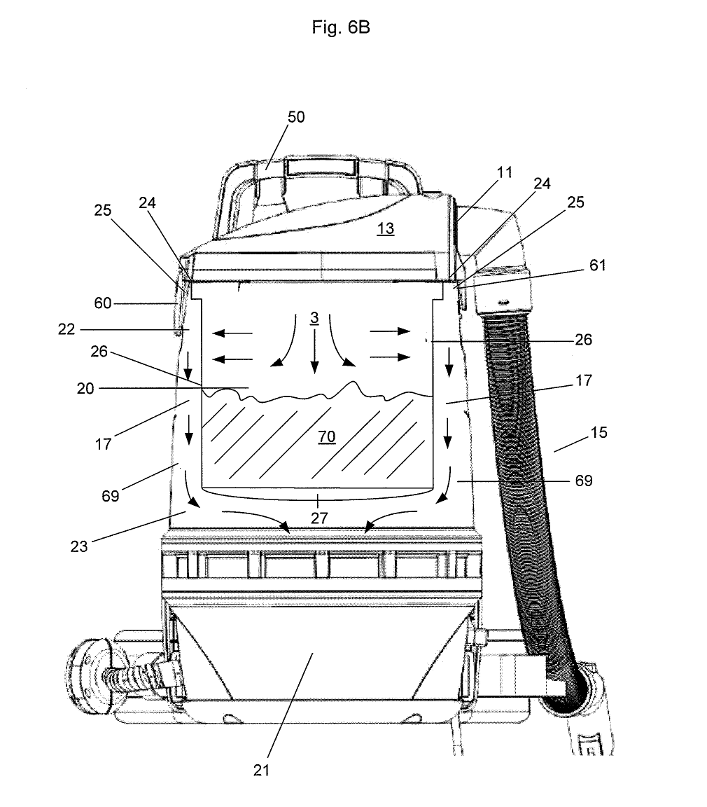

As the cross-section 19 of the first bag filter 3 is substantially constant and sized to be received by the upper portion 22, a space 17 (shown in FIG. 6A) is formed between the wall portion 28 of the upper canister 20 and the side portions 26 of the first bag filter 3. Furthermore, as the cross-section of the upper canister 20 increases from the upper portion 22 towards the lower portion 23, the space 17 is greater toward the lower portion 23 of the upper canister 20 than the upper portion 22.

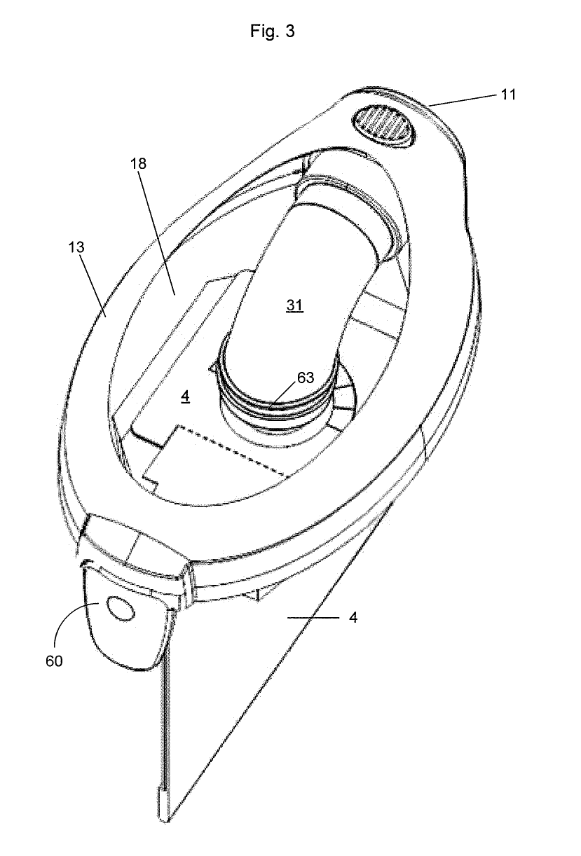

The first bag filter 3 is configured to house a second bag filter 4. The second bag filter 4 is a paper bag type filter and has a circular opening 30 on an upper surface into which the air and any entrained material initially passes before entering the second bag filter 4. The circular opening is configured to couple to the inlet 11 via a clear elbow inlet 31 provided with the lid 13 (shown in FIG. 3). The lid 13 also includes a clear lens portion 18 such that a user is able to see into the clear elbow inlet 31 to visually identify if any entrained material is passing from the inlet 11 into the first bag filter 3 and second bag filter 4. This aspect can be advantageous in assisting to identify if there is a blockage in the vacuum pipe assembly 15 or the first elbow 14. Furthermore, this visibility can be advantageous in assisting to identify if the first bag filter 3 and/or second bag filter 4 require maintenance or is full and is therefore advantageous to aid in identification of blockages in the filtration assembly 1.

The second bag filter 4 is made from paper with a filtration efficiency of approximately 93.2% using test dust. The test dust consisting of particles between 0 to 80 micros as per the EN 60312 standard. The second bag filter 4 filters out a portion of the entrained material from the air and stores the portion of entrained material therein. After the air passes through the second bag filter 4, the air then passes into and through the first bag filter 3. The first bag filter 3 is made of a polyester needle felt material that has a filtration efficiency of 96.9% using test dust as defined above. The polyester needle felt material is composed of one or more polyester fibres with different diameters. These polyester fibres include fibres with diameters of 0.1 mm, 0.2 mm and 0.25 mm. This “blended fibre” technology approach to the design of the first filter provides a low level of impedance to the air flow whilst maintaining a high level of filtration. As the air flows through the first bag filter 3 a further portion of the entrained material is filtered from the air. This material filtered from the air is then stored and accumulates within the first bag filter 3. The first bag filter 3 is treated with special release agents to reduce adhesion of entrained material such as dust to the surface of the first bag filter 3. This reduced adhesion allows the entrained material, such as dust, to be removed by brushing the surface of the first bag filter 3.

After the air has passed through the first bag filter 3 and second bag filter 4, the air and any remaining entrained material passes through the panel filter 5 which is located between the base portion 27 of the first bag filter 3 and motor driven impeller 10. The panel filter 5 has a filtration efficiency of 99.76% using the test dust.

Therefore, it may be appreciated that the first bag filter 3, the second bag filter 4 and the panel filter 5 provide a series of filters in which each filter in the series has an increased filtration efficiency thereby progressively filtering out finer dust as air and any entrained material passes through the filtration assembly 1. This series of filters providing a combined efficiency of 99.9995% using test dust which enters the filtration assembly 1 through the inlet 11.

The upper canister 20 is provided with a base 35 which generally separates the upper canister 20 from the lower canister 21. The base 35 is coupled to the upper canister by screws 37 and a seal 36 is provided between the upper canister 20 and base 35. The base 35 includes a protruding rim 39 skirting a grated support 38 into which the panel filter 5 may be inserted. The grating of the grated support 38 is configured to provide a further filter to ensure large particles do not get sucked into the motor driven impeller 10 which is located below the grated support 38.

The base 35 is skirted by a baffle 40 that provides the outlet 12. The baffle 40 provides an enlarged aperture relative to the motor driven impeller 10 such that the velocity of the air exiting the filtration assembly 1 slows down thereby reducing the noise. The lower canister 21 is then coupled to the base 35 via the baffle 40, the lower canister having cladding 41 and base section 42 thereby providing a housing for the motor driven impeller 10 and electrical components 43.

In a preferred form, the baffle 40 does not include acoustic materials as entrained material may become clogged in the acoustic material which may cause the passage of exhaust air to become blocked. Instead the baffle 40 is provided in the form of a triple wall exhaust barrier that provides acoustic attenuation by absorbing and reflecting sound waves, then, by diffusing the air through a large exhaust aperture, noise is attenuated by reduction in air velocity. The benefit is that there is no need for service, maintenance, adjustment, and the chance of blockage of the exhaust 12 is reduced.

A back pack assembly 50 is coupled to the filtration assembly 1 so that the filtration assembly 1 is cartable on the back of a user. The back pack assembly 50 includes a back support frame 54, an upper back support 51, a shoulder harness 52, a lower back support 55 and a padded belt 53.

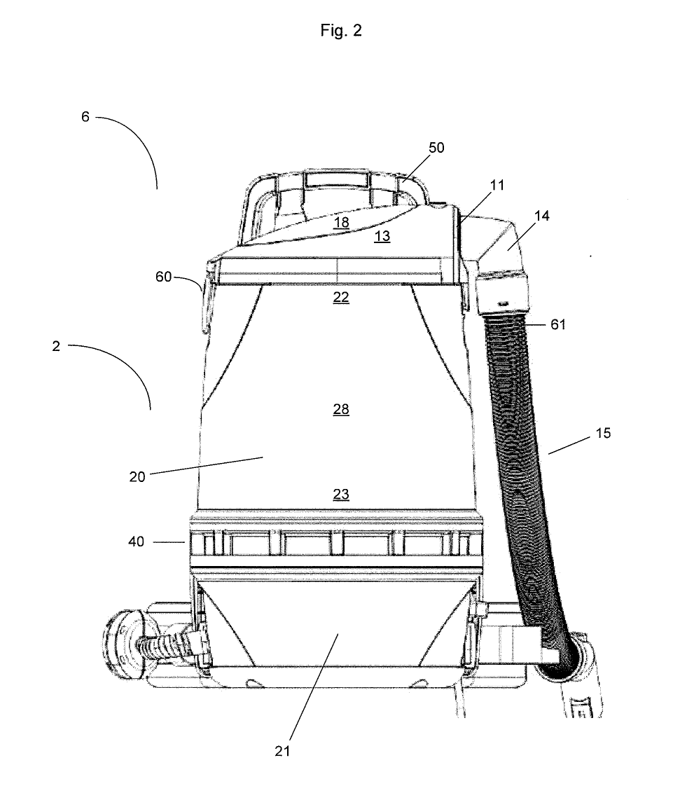

FIG. 2, shows a collated front view of the suction cleaning device 6, including the housing 2 concealing the first bag filter 3, second bag filter 4 and a panel filter 5. In this configuration, the lid 13 is coupled to the upper portion 22 of the upper canister 20 via a releasable magnetic flexible latch 60 which is engaged with a catch 61 on an opposing side of the lid 14.

Referring now to FIG. 3, the clear elbow 31 turns the air and entrained material arriving at the inlet 11 through approximately 90 degrees and expels the air and entrained material downwardly into the second bag filter 4 that is coupled to an outlet 63 of the clear elbow 31. In this configuration, the air and entrained material is directed through the lid 2 rather than into the lid 2 which assists to reduce the impedance to air flow caused by the lid 2. Furthermore, as the inlet elbow 31 directs air away from the clear lens portion 18, any entrained material in the air, for example sand, does not impact and scuff the clear lens portion 18, which can cause the clear lens portion 18 to become unclear and hard to see through.

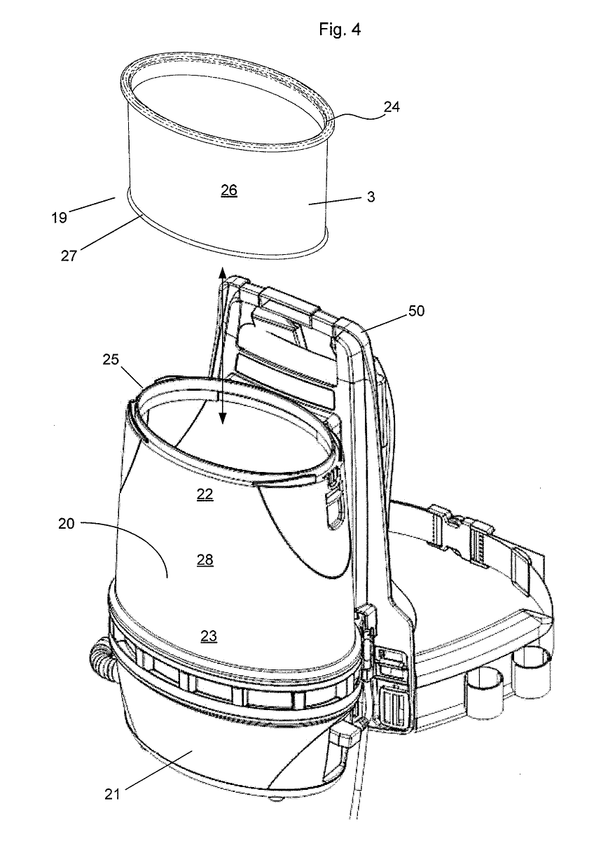

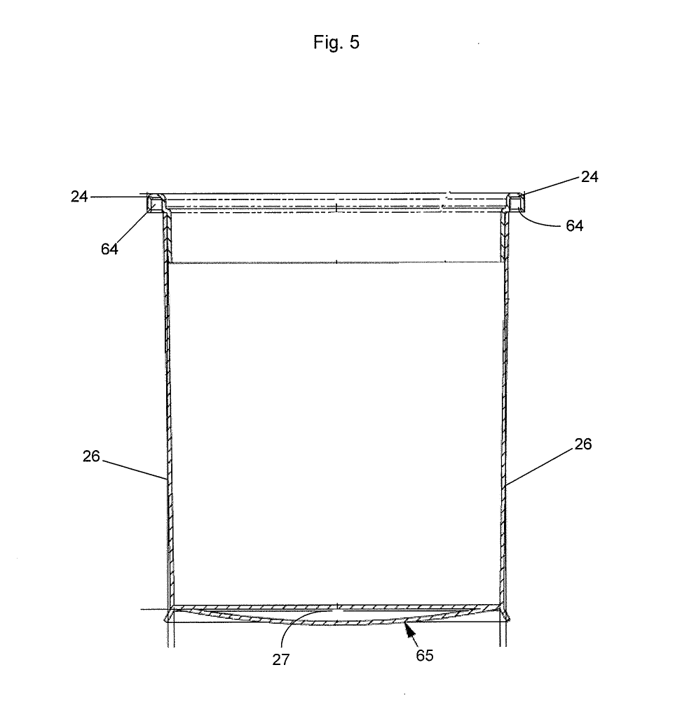

In FIG. 4, the first bag filter 3 is shown as being removable through the upper portion 22 of the upper canister 20. When the first bag filter 3 is inserted into the upper canister 20, the rim 24 which is provided in the form of an over-turned flange 64 (see FIG. 5) sits on the lip 25 of the upper portion 22 such that the first bag filter 3 is suspended from the lip 25 and extends downwardly into the lower portion 23 of the upper canister 20 of the housing body 2, as is shown in FIGS. 6A and 6B.

FIG. 6A shows the first bag filter 3 suspended from the lip 25 of the upper portion 22 with the side portions 26 and base portion 27 of the bag filter extends downwardly into the lower portion 23 of the upper canister 20. As the side portions 26 and the base portion 27 of the first bag filter 3 are composed of semi-permeable polyester needle felt filter material, air is able to pass through the side portions 26 and the base portion 27.

The space 17 between the wall portion 28 and side portion 26 provides a gap 69 for air surrounding the side portions 26 of the first bag filter 3. Accordingly, the motor driven impeller 10 is able to draw air through both the side portions 26 and the base portion 27 of the first bag filter 3. As air is able to be drawn through the side portions 26 and the base portion 27 of the first bag filter 3, the surface area from which air may be drawn is larger in area than if air is only drawn through the base portion 27 of the first bag filter 3 or where only a small air gap is provided restricting air flow.

As air is able to the drawn through both the side portions 26 and the base portion 27, it should be appreciated that the presence of the gap 69 is able to decrease the impedance of air flowing through the filtration assembly 1. This allows a higher intake velocity at the inlet 11, and accordingly in the vacuum pipe assembly 15. This increases the performance of the suction cleaning device 6 to entrain dirt, dust and other materials. In another aspect, the air 69, by increasing the surface air through which air may pass, allows a finer filter to be used than could otherwise be used. Therefore, high filtration efficiency is able to be achieved whilst maintaining low impedance to the air flow and hence maintaining a high intake velocity.

FIG. 6B, shows the situation where the first bag filter 3 is filled with entrained material 70. This entrained material restricts air flow through the base portion 27 of the first bag filter 3. In this situation, the gap 69 provides a passage for air flow through the side portions 26 as indicated by the arrows.

This passage of air flow through the gap 69 allows the impedance of the filtration assembly to remain relatively low as the first bag filter 3 is filled with the material 70. By maintaining this low impedance to air flow, the suction velocity through the vacuum pipe assembly 15 is able to be maintained, as the first bag filter 3 is filled with the material 70. This has an advantage of maintaining high suction through the vacuum pipe assembly 15 for a longer period of time before the first bag filter 3 needs to be emptied or cleaned.

In another aspect, the second bag filter 4 that is housed within the first bag filter 3 may form the material 70, bulging or generally restricting air flow through the base portion 27 of the first bag filter 3 such that air flow is drawn through the side portions 26 of the first bag filter 3. Alternatively, the first bag filter 3 could be used without the second bag filter 4, therefore the first bag filter 3 would contain the bulk of the entrained material that enters the filtration assembly 1 through the inlet 11.

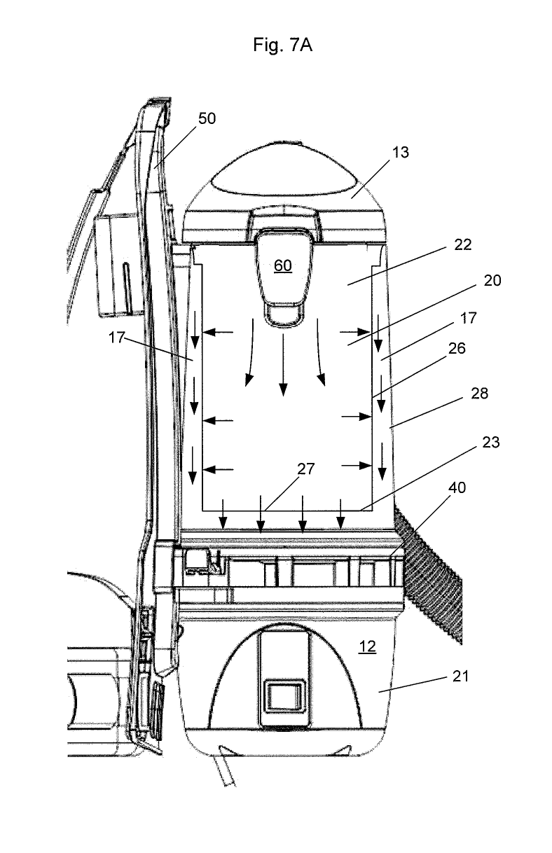

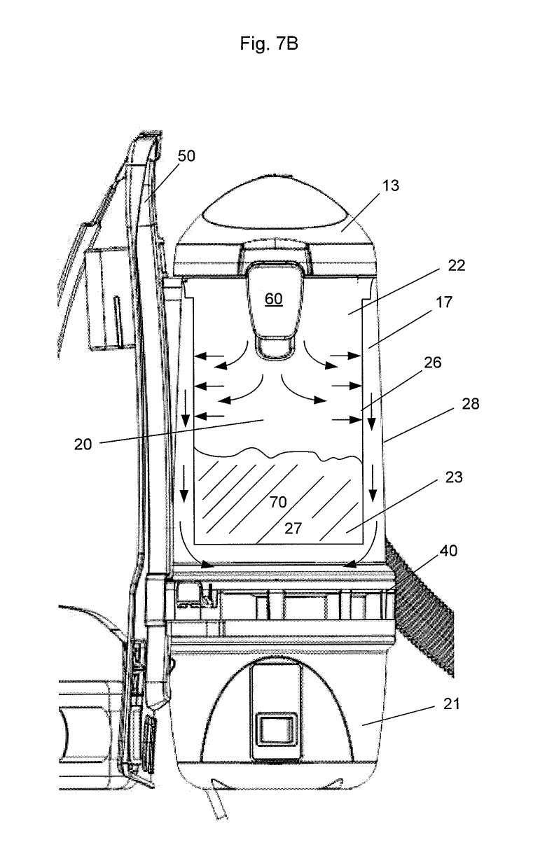

FIG. 7A shows a side view of the first bag filter 3 suspended from the lip 25 of the upper portion 22 with the side portions 26 and base portion 27 of the first bag filter 3 extending downwardly into the lower portion 23 of the upper canister 20. The base portion 27 of the first bag filter 3 is unobstructed and air-flow is able to pass there through, as well as through the side portions 26 as indicated by the arrows.

FIG. 7B, shows an analogous situation to FIG. 6B wherein air flow through the base portion 27 is obstructed by material 70 that is captured within the first bag filter 3. Accordingly, the air flow, as indicated by arrows on the Figure, travels increasingly through the side portions 26 to compensate for the reduced air-flow through the base portion 27. This aids to maintain the performance of the filtration assembly, and hence the suction cleaning device, by maintaining a relatively high suction velocity though the vacuum pipe assembly 15. Additionally, the gap 69 shown in FIGS. 6A, 6B, 7A and 7B aids to provide an air reservoir for providing additional cooling air to the motor driven impeller 10.

The motor driven impeller 10 can cause a high vacuum loading to be generated inside the upper canister 20. Due to the elliptical shape of the upper canister 20, this loading is able to distort the shape of upper canister 20, breaking the seal between the lid 13 and upper canister 20, such that an air passage is formed between the lid 13 and the lip 25 of the upper portion 22 of the upper canister 20. This air passage allows cool external air to pass into the gap 69, this air is then drawn into the motor driven impeller 10 providing cooling and an air by-pass in a blockage or overload situations.

For the air passage to form between the lid 13 and the lip 25 the releasable magnetic flexible latch 60 provides some play or movement, allowing the lid 13 and the lip 25 to move. This flexible latch 60 is made from a flexible thermoplastic elastomer that provides flexibility which allows the relative movement or “shape adjusting” between the lid 13 and the lip 25. Additionally, the elliptical shape of housing body 2 provides for better balance for the user/operator when the unit is strapped onto a user's/operator's back by keeping the profile and weight of the vacuum unit closer to the wearer's body providing a better centre of mass compared to typical back pack type vacuum cleaners.

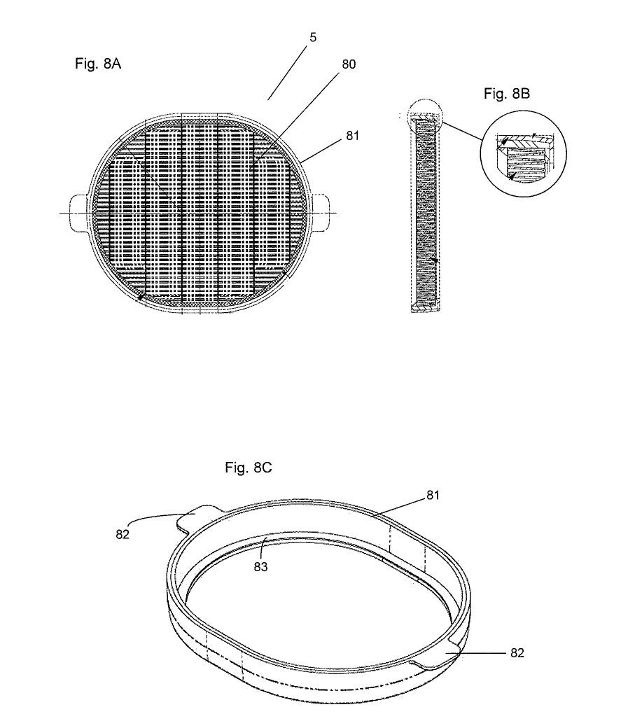

Referring to FIG. 8A, the panel filter 5 is configured to receive the air and any unfiltered entrained material from the first bag filter 4. The panel filter 5 further includes a layer of polypropylene sandwiched between thin protective polyethylene terephthalate that forms a pleated filter surface 80. The composite structure provides excellent filtration characteristic with low impedance, and allows the user to clean the media surface by washing and brushing. FIG. 8B shows detail of the pleated panel filter 80 is constructed as a vee pleat panel filter such that the filtration surface area is significantly increased over the footprint cross-sectional area of the panel filter 5. The panel filter 5 has a 99.76% filtration efficiency using EN 60312 test dust.

The sides of the pleated filter surface 80 are then adhered to the panel filter housing 81. The panel filter housing 81 is oblate circular in shape and has a shelf 83 skirting the downward facing portion of the panel filter housing 81. The shelf 83 provides additional support to the pleated filter surface 80, aiding to retain the pleated filter surface 80 during suction through the filtration assembly 1. The upper portion of the panel filter housing 81 includes tabs 82 that are able to be clasped by a user to remove the panel filter housing 81 from the upper canister 20.

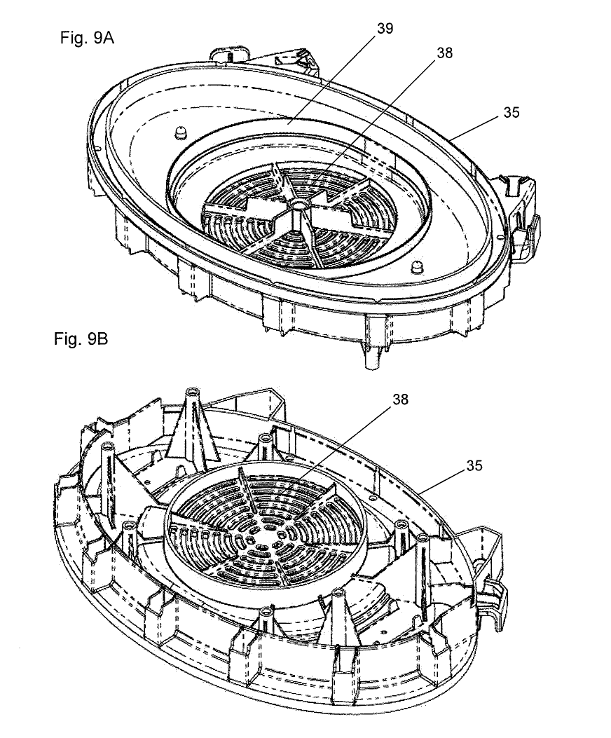

FIGS. 9A and 9B show an upright and upside down view of the base 35 of the upper canister respectively. The panel filter housing 81 is received by the recess formed by the protruding rim 39 to retain the panel filter 5 above the grated support 38. In this configuration, the panel filter 5 is retained by a friction fit and may be removed by the tabs 82 without the need to unclip the panel filter. In this respect, the first bag filter 3 and the panel filter 5 are able to be removed via the lid 13 without the need to unclip or use tooling, making is easy for a user to access and maintain these components.

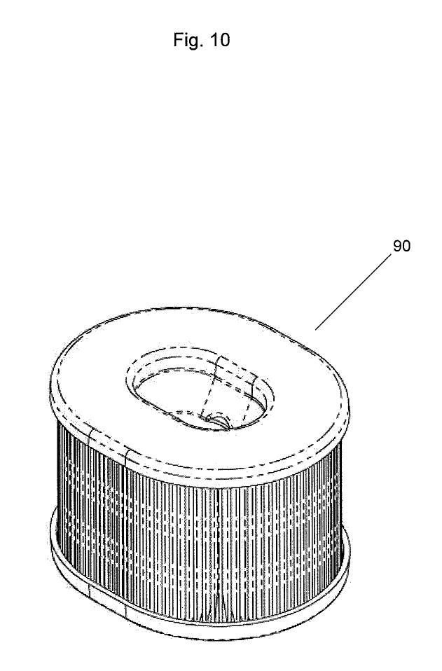

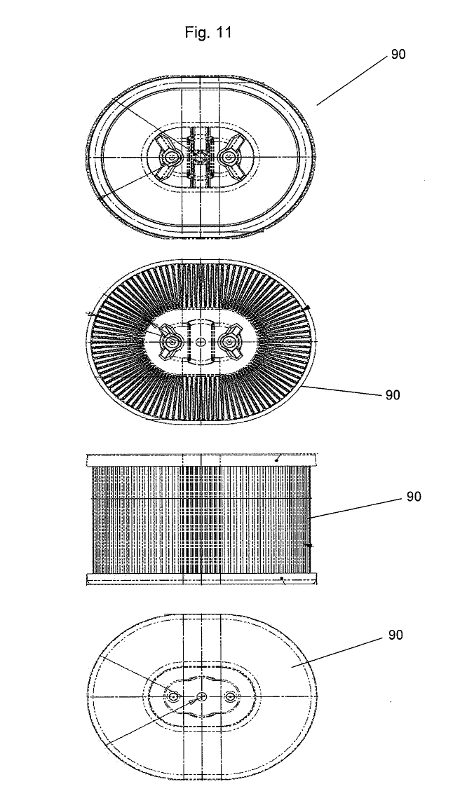

FIG. 10, shows a HEPA filter 90 that may be used instead of the panel filter in situations where additional filtration is required. The HEPA filter 90 provides a filtration efficiency of 99.97% filtration efficiency at 0.3 microns. The HEPA filter 90 is PTFE coated, allowing the filter to be washed by agitation when cleaning, physical contact with the media should not be made because of potential damage, detrimental to performance. The HEPA filter 90 is seated on the base 35 of the upper canister. FIG. 11, also provides further details of the HEPA filter 90.

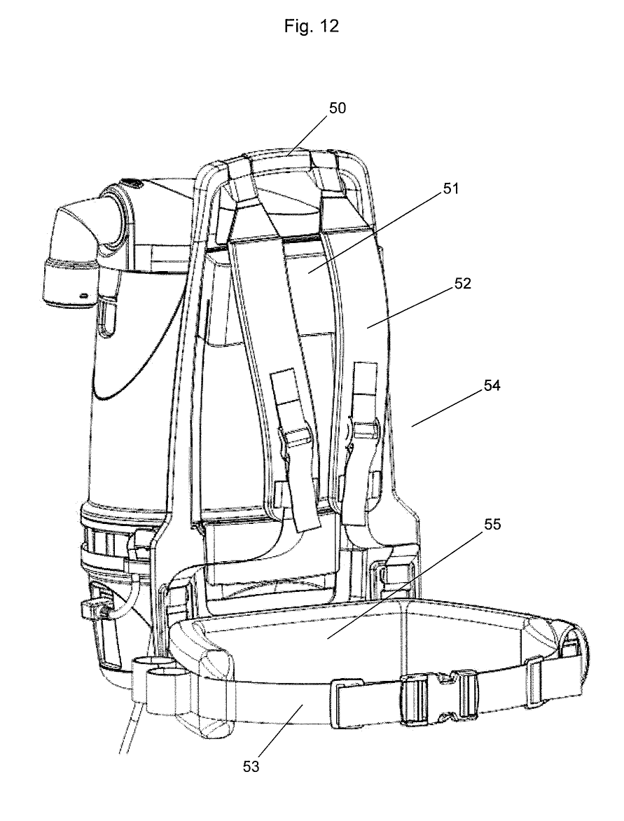

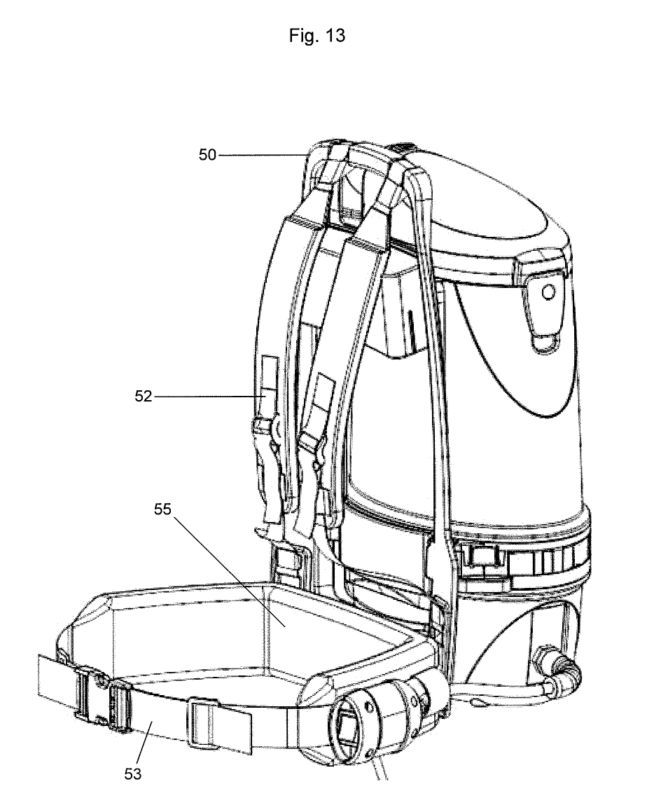

Now referring to FIGS. 12 and 13, the back pack assembly 50 is coupled to the filtration assembly 1 so that the filtration assembly 1 is cartable on the back of a user. The back pack assembly 50, includes a back support frame 54, an upper back support 51, a shoulder harness 52, a lower back support 55 and a padded belt 53.

The location of the upper back support 51 and lower back support 55 defying traditional design practices on harness construction as the back pad in the lower thoracic area has been completely removed to improve ventilation. The upper back support 51 and lower back support 55 contact the back in the upper thoracic and lower cervical region respectively. The upper back support 51 and the lower back support 55 are substantially formed of a thick composite foam structure providing a combination of firmness and softness for soft body tissue protection. The shoulder harness 52 is wide, long and contoured, providing for a comfortable fit. The padded belt 53 also uses a foam composite, and has provision to carry light weight accessories such as upholstery and crevice tools. All padding and supports are attached using “tools free” assembly such that the user can easily replace these parts, without having to resort to specialist service agents.

The invention has been described by way of non-limiting example only and many modifications and variations may be made thereto without departing from the spirit and scope of the invention described.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

What is claimed is:

1. A filtration assembly for use with a suction cleaning device, the filtration assembly including a housing body for housing one or more filters; and a motor driven impeller which generates suction for drawing air and any entrained material into an inlet through the one or more filters and discharging the air through an outlet;
wherein the one or more filters includes a first bag filter received by the housing body, the first bag filter including a base portion and a side portion which define a cavity for holding any material that cannot pass through the first bag filter; and,
wherein the side portion of the first bag filter is laterally spaced apart from a wall portion of the housing body such that a gap is formed between the side portion and the wall portion.

2. The filtration assembly according to claim 1, wherein the side portion of the first bag filter is composed of a filtering material through which air is able to be drawn; and, wherein suction of the motor generates airflow in the gap by drawing air through the side portion of the first filter bag.

3. The filtration assembly according to claim 2, wherein the base portion of the filter bag filter is composed of a filtering material through which air is able to be drawn.

4. The filtration assembly according to claim 2, wherein the housing body includes an upper portion through which the first bag filter is received and a lower portion, wherein the side portion and base portion of the first bag filter extend down into the lower portion of the housing body wherein the gap between the wall portion of the housing body and the side portion of the first bag filter is greater at the lower portion of the housing body than the upper portion.

5. The filtration assembly according to claim 4, wherein the side portion and the wall portion diverge towards the lower portion of the housing body, the gap increasing towards the lower portion of the housing body.

6. The filtration assembly according to claim 4, wherein the cross-section of the lower portion is greater than the cross-section of the upper portion such that the cross-section of the housing body fans outwardly from the upper portion to the lower portion; and,
wherein the first bag filter has a constant a cross-section that is substantially similar to the cross-section of the upper portion whereby as the first bag filter extends downwardly from the upper portion towards the lower portion, an increasing gap is formed between the side portions of the first bag filter and the housing body.

7. The filtration assembly according to claim 4, wherein the housing body cross section is substantially elliptical in shape.

8. The filtration assembly according to claim 4, wherein the first bag filter is provided in the form of a receptacle extending downwardly into the cavity of the housing body wherein the receptacle has an open end suspended from a lip of an upper portion of the housing body to receive the air and any entrained material.

9. The filtration assembly according to claim 4, wherein the first bag filter is made of a polyester needle felt material that has a filtration efficiency of 96.9% using test dust.

10. The filtration assembly according to claim 4, wherein the first bag filter is composed of one or more polyester fibres with different diameters.

11. The filtration assembly according to claim 10, where the one or more polyester fibres with different diameters include polyester fibres of 0.1 mm, 0.2 mm and 0.25 mm in diameter.

12. The filtration assembly according to claim 4, wherein the gap provides a space for the dissipation of heat generated by the motor driver impeller.

13. The filtration assembly according to claim 4, wherein the one or more filters further includes a panel filter to receive the air and any unfiltered entrained material from the first bag filter wherein the panel filter is secured within the lower portion of the housing body.

14. The filtration assembly according to claim 13, wherein the panel filter further includes a layer of polypropylene sandwiched between thin protective polyethylene terephthalate.

15. The filtration assembly according to claim 13, wherein the panel filter is constructed as a vee pleat panel filter such that the filtration surface area is significantly increased over the footprint cross-sectional area of the panel filter.

16. The filtration assembly according to claim 13, wherein the panel filter is a HEPA filter.

17. The filtration assembly according to claim 13, wherein the bag filter and panel filter are able to be installed or removed from the casing through an opening at the top of the upper portion of the housing body.

18. The filtration assembly according to claim 4, wherein the one or more filters includes a second bag filter that is housed within the first bag filter.

19. The filtration assembly according to claim 18, wherein the second bag filter is composed of a paper material.

20. The filtration assembly according to claim 18, wherein the second bag filter is micro fibre lined.

21. A filtration assembly for use with a suction cleaning device, the filtration assembly including a housing body for housing a series of filters and an impeller driven by an electric motor for drawing air and any entrained material into an inlet, through the series of filters and discharging the air and any unfiltered entrained material through an outlet; and
wherein the housing body includes an upper portion and a lower portion wherein the cross-section of the housing body is greater in the lower portion than the upper portion; and
wherein the series of filters includes a first bag filter, a second bag filter housed within the first bag filter and a panel filter through which the air and any entrained material passes; and
wherein the first bag filter has a cross-section that is substantially similar to the cross-section of the upper portion whereby as the first bag filter extends downwardly from the upper portion towards the lower portion, an increasing gap is formed between a side portion of the first bag filter and a wall portion of the housing body.
